(19) United States
(12) Patent Application Publication
(10) Pub. No.: US 2018/0242154 A1
(43) Pub. Date: Aug. 23, 2018

(54) SYSTEM AND METHOD FOR AUTOMATIC PROVISIONING OF MULTI-TENANT WIRELESS LOCAL AREA NETWORKS

(71) Applicant: Dell Products L.P., Round Rock, TX (US)

(72) Inventors: Lee E. Ballard, Georgetown, TX (US); Jon F. Lewis, Pflugerville, TX (US); Jason B. Kilpatrick, Austin, TX (US)

(21) Appl. No.: 15/435,613

(22) Filed: Feb. 17, 2017

(51) Int. Cl. H04W 12/08; H04W 4/00; H04W 4/02; H04L 29/12; H04L 29/06

(52) U.S. Cl. CPC H04W 12/08; H04W 4/001; H04W 4/008; H04W 84/12; H04L 61/2007; H04L 63/10; H04W 4/023

(57) ABSTRACT

An information handling system may implement a method for automatically provisioning multi-tenant wireless local area networks. The method may include detecting initiation, by a client in a given tenant, of a provisioning of a wireless local area network (LAN), and creating, automatically and in response to the detecting, a secure wireless LAN, where the LAN is to be isolated from clients in other tenants. Creating the secure wireless LAN may include allocating a virtual local area network (VLAN) on behalf of the tenant, associating the VLAN with the tenant, and associating a locally unique identifier with the VLAN. The method may also include determining, subsequent to the creating, that a disconnection condition for the VLAN has been met, and dismantling, automatically and in response to the determination, the VLAN, where dismantling the VLAN may include disassociating the locally unique identifier from the VLAN, and deallocating the VLAN.

### BACKGROUND

### Field of the Disclosure

This disclosure relates generally to information handling systems and, more particularly, to automatic provisioning of multi-tenant wireless local area networks.

### Description of the Related Art

As the value and use of information continues to increase, individuals and businesses seek additional ways to process and store information. One option available to users is information handling systems. An information handling system generally processes, compiles, stores, and/or communicates information or data for business, personal, or other purposes thereby allowing users to take advantage of the value of the information. Because technology and information handling needs and requirements vary between different users or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, airline reservations, enterprise data storage, or global communications. In addition, information handling systems may include a variety of hardware and software components that may be configured to process, store, and communicate information and may include one or more computer systems, data storage systems, and networking systems.

Shared Wi-Fi networks can present a security concern, especially in a multi-tenant environment. For example, malicious clients can snoop sensitive information and compromise the security of other clients. In a public or shared environment, such as a flexible workspace or a multi-tenant datacenter, end-to-end security is desired and may even be required.

### SUMMARY

In one aspect, a disclosed method is for automatically provisioning multi-tenant wireless local area networks. In at least some embodiments, the method may include, in an information handling system, detecting initiation, by a client in a given tenant, of a provisioning of a wireless local area network (LAN), and creating, automatically and in response to the detecting, a secure wireless LAN, where the LAN is to be isolated from clients in tenants other than the given tenant. Creating the secure wireless LAN may include allocating a virtual local area network (VLAN) on behalf of the tenant, associating the VLAN with the tenant, and associating a locally unique identifier with the VLAN. The method may also include determining, subsequent to the creating, that a disconnection condition for the VLAN has been met, and dismantling, automatically and in response to the determination, the VLAN, where dismantling the VLAN may include disassociating the locally unique identifier from the VLAN, and deallocating the VLAN.

In any of the disclosed embodiments, detecting initiation, by a client in a given tenant, of a provisioning of a wireless LAN may include receiving from the client, a provisioning packet.

In any of the disclosed embodiments, creating the secure wireless LAN further may include allocating an IP address range for the tenant.

In any of the disclosed embodiments, the method may further include communicating the locally unique identifier to one or more wireless access points.

In any of the disclosed embodiments, detecting initiation, by a client in a given tenant, of a provisioning of a wireless LAN may include receiving a request from the client for creation of a locally unique identifier for a VLAN.

In any of the disclosed embodiments, the method may further include adding, to the VLAN, one or more endpoint devices or shared resources in the information handling system that the client is authorized to access.

In any of the disclosed embodiments, determining that a disconnection condition for the VLAN has been met may include detecting that the client has disconnected from the VLAN.

In any of the disclosed embodiments, determining that a disconnection condition for the VLAN has been met may include determining that a predetermined timeout period or lease period for the VLAN has expired.

In any of the disclosed embodiments, detecting initiation, by a client in a given tenant, of a provisioning of a wireless LAN may include determining, using a near field communication mechanism, that a mobile device of the client is in close proximity to a server in the information handling system, and receiving, from the mobile device, a request to initiate provisioning of a wireless LAN.

In any of the disclosed embodiments, the method may further include adding one or more other clients in the given tenant to the VLAN.

Another disclosed aspect includes an information handling system including at least one wireless access point, and a network subdivided into a plurality of virtual local area networks (VLANs). The information handling system may further include circuitry to detect initiation, by a client in a given tenant, of a provisioning of a wireless local area network (LAN), and to create, automatically and in response to the detection, a secure wireless LAN, where the LAN is to be isolated from clients in tenants other than the given tenant. To create the secure wireless LAN, the information handling system may include circuitry to allocate a VLAN on behalf of the tenant, to associate the VLAN with the tenant, and to associate a locally unique identifier with the VLAN. The information handling system may also include circuitry to determine, subsequent to the creation, that a disconnection condition for the VLAN has been met, and to dismantle, automatically and in response to the determination, the VLAN. To dismantle the VLAN, the information handling system may include circuitry to disassociate the locally unique identifier from the VLAN, and to deallocate the VLAN.

In any of the disclosed embodiments, to detect initiation, by a client in a given tenant, of a provisioning of a wireless LAN, the information handling system may include circuitry to receive from the client, a provisioning packet.

In any of the disclosed embodiments, to create the secure wireless LAN, the information handling system may include circuitry to allocate an IP address range for the tenant.

In any of the disclosed embodiments, the information handling system may further include circuitry to communicate the locally unique identifier to one or more wireless access points.

In any of the disclosed embodiments, to detect initiation, by a client in a given tenant, of a provisioning of a wireless LAN, the information handling system may include circuitry to receive a request from the client for creation of a locally unique identifier for a VLAN.

In any of the disclosed embodiments, the information handling system may further include circuitry to add, to the VLAN, one or more endpoint devices or shared resources that the client is authorized to access.

In any of the disclosed embodiments, to determine that a disconnection condition for the VLAN has been met, the information handling system may include circuitry to detect that the client has disconnected from the VLAN.

In any of the disclosed embodiments, to determine that a disconnection condition for the VLAN has been met, the information handling system may include circuitry to determine that a predetermined timeout period or lease period for the VLAN has expired.

In any of the disclosed embodiments, to detect initiation, by a client in a given tenant, of a provisioning of a wireless LAN, the information handling system may include circuitry to determine, using a near field communication mechanism, that a mobile device of the client is in close proximity to a server in the information handling system, and to receive, from the mobile device, a request to initiate provisioning of a wireless LAN.

In any of the disclosed embodiments, the information handling system may further include circuitry to add one or more other clients in the given tenant to the VLAN.

### BRIEF DESCRIPTION OF THE DRAWINGS

For a more complete understanding of the present invention and its features and advantages, reference is now made to the following description, taken in conjunction with the accompanying drawings, in which:

FIG. 1 is a block diagram of selected elements of an embodiment of an information handling system;

FIG. 2 is a block diagram of selected elements of an embodiment of an information handling system that includes multiple servers and a multi-server manager;

FIG. 3 is a block diagram of selected elements of an information handling system in a modular server architecture, according to some embodiments;

FIG. 4 is a block diagram of selected elements of an information handling system in a stacked chassis architecture, according to some embodiments;

FIG. 5 is flowchart illustrating selected elements of a method for automatically provisioning a multi-tenant wireless local area network, according to some embodiments;

FIG. 6 is a sequence diagram illustrating operations for automatically creating a secure Wi-Fi network based on provisioning information from a client, according to at least one embodiment; and

FIG. 7 is a sequence diagram illustrating operations for automatically allocating a service set identifier (SSID) for a client in a multi-tenant environment, according to at least one embodiment.

### DESCRIPTION OF PARTICULAR EMBODIMENT(S)

In the following description, details are set forth by way of example to facilitate discussion of the disclosed subject matter. It should be apparent to a person of ordinary skill in the field, however, that the disclosed embodiments are exemplary and not exhaustive of all possible embodiments.

As used herein, a hyphenated form of a reference numeral refers to a specific instance of an element and the un-hyphenated form of the reference numeral refers to the collective or generic element. Thus, for example, widget “72-1” refers to an instance of a widget class, which may be referred to collectively as widgets “72” and any one of which may be referred to generically as a widget “72”.

For the purposes of this disclosure, an information handling system may include an instrumentality or aggregate of instrumentalities operable to compute, classify, process, transmit, receive, retrieve, originate, switch, store, display, manifest, detect, record, reproduce, handle, or utilize various forms of information, intelligence, or data for business, scientific, control, entertainment, or other purposes. For example, an information handling system may be a personal computer, a PDA, a consumer electronic device, a network storage device, or another suitable device and may vary in size, shape, performance, functionality, and price. The information handling system may include memory, one or more processing resources such as a central processing unit (CPU) or hardware or software control logic. Additional components or the information handling system may include one or more storage devices, one or more communications ports for communicating with external devices as well as various input and output (I/O) devices, such as a keyboard, a mouse, and a video display. The information handling system may also include one or more buses operable to transmit communication between the various hardware components.

For the purposes of this disclosure, computer-readable media may include an instrumentality or aggregation of instrumentalities that may retain data and/or instructions for a period of time. Computer-readable media may include, without limitation, storage media such as a direct access storage device (e.g., a hard disk drive or floppy disk), a sequential access storage device (e.g., a tape disk drive), compact disk, CD-ROM, DVD, random access memory (RAM), read-only memory (ROM), electrically erasable programmable read-only memory (EEPROM), and/or flash memory (SSD); as well as communications media such wires, optical fibers, microwaves, radio waves, and other electromagnetic and/or optical carriers; and/or any combination of the foregoing.

Multi-tenancy and security continue to grow in importance as the density of datacenter solutions increase. Servers and chassis are continuing to realize increased compute power and there is a growing desire to subdivide these resources whenever possible. As described herein, an information handling system may, in some embodiments, implement a method for automatically provisioning multi-tenant wireless local area networks and subsequently dismantling them. The disclosed techniques, sometimes referred to as “variable SSID” may increase the security of “at-the-box” networking solutions and may give the customer greater control over the access to their resources. In at least some embodiments, the disclosed techniques may allow a wireless LAN to be automatically provisioned from a client. In such embodiments, rather than having to request the creation of a wireless LAN from a system administrator, the client may automatically provision the network when joining the network. In some embodiments, this may involve the client providing a provisioning packet, and a secure wireless LAN may be automatically created based on what the client provides to the back end. In some embodiments, the variable SSID approach described herein may be used to create a short-lived, private wireless LAN over which a group of users who are working together in a shared work space can collaborate.

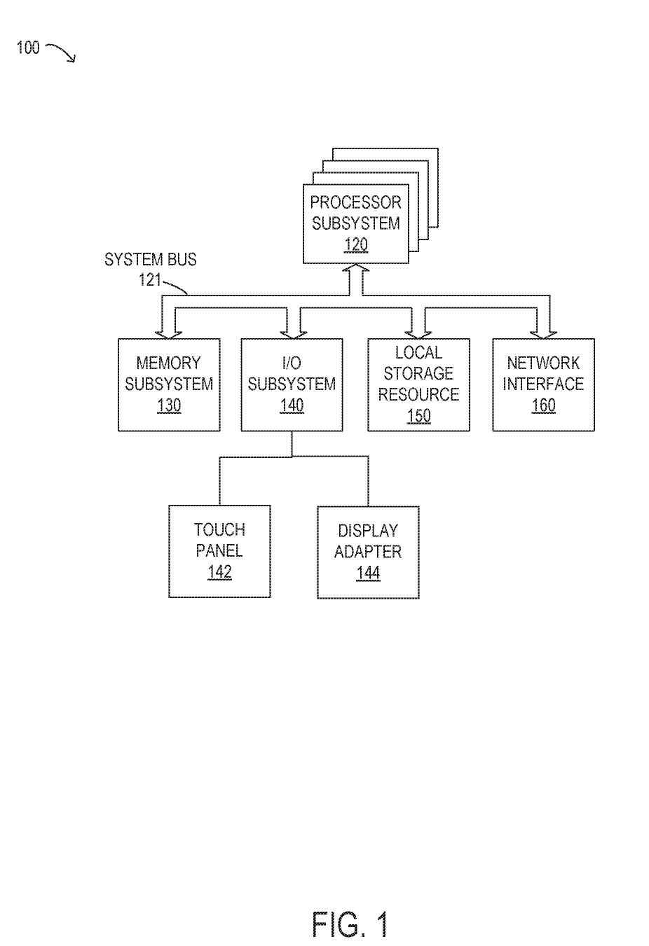

Particular embodiments are best understood by reference to FIGS. 1-7, in which like numbers are used to indicate like and corresponding parts.

Turning now to the drawings, FIG. 1 illustrates a block diagram depicting selected elements of an embodiment of information handling system 100. As described herein, information handling system 100 may represent a personal computing device, such as a personal computer system, a desktop computer, a laptop computer, a notebook computer, etc., operated by a user, or may represent one of multiple computing devices operating in a public environment, a corporate environment or a datacenter. In various embodiments, information handling system 100 may be operated by the user using a keyboard and a mouse (not shown).

As shown in FIG. 1, components of information handling system 100 may include, but are not limited to, processor subsystem 120, which may comprise one or more processors, and system bus 121 that communicatively couples various system components to processor subsystem 120 including, for example, a memory subsystem 130, an I/O subsystem 140, local storage resource 150, and a network interface 160. System bus 121 may represent a variety of suitable types of bus structures, e.g., a memory bus, a peripheral bus, or a local bus using various bus architectures in selected embodiments. For example, such architectures may include, but are not limited to, Micro Channel Architecture (MCA) bus, Industry Standard Architecture (ISA) bus, Enhanced ISA (EISA) bus, Peripheral Component Interconnect (PCI) bus, PCI-Express bus, HyperTransport (HT) bus, and Video Electronics Standards Association (VESA) local bus.

In FIG. 1, network interface 160 may be a suitable system, apparatus, or device operable to serve as an interface between information handling system 100 and a network (not shown). Network interface 160 may enable information handling system 100 to communicate over the network using a suitable transmission protocol and/or standard, including, but not limited to, transmission protocols and/or standards enumerated below with respect to the discussion of network 155. In some embodiments, network interface 160 may be communicatively coupled via the network to a network storage resource (not shown). The network coupled to network interface 160 may be implemented as, or may be a part of, a storage area network (SAN), personal area network (PAN), local area network (LAN), a metropolitan area network (MAN), a wide area network (WAN), a wireless local area network (WLAN), a virtual private network (VPN), an intranet, the Internet or another appropriate architecture or system that facilitates the communication of signals, data and/or messages (generally referred to as data). The network coupled to network interface 160 may transmit data using a desired storage and/or communication protocol, including, but not limited to, Fibre Channel, Frame Relay, Asynchronous Transfer Mode (ATM), Internet protocol (IP), other packet-based protocol, small computer system interface (SCSI), Internet SCSI (iSCSI), Serial Attached SCSI (SAS) or another transport that operates with the SCSI protocol, advanced technology attachment (ATA), serial ATA (SATA), advanced technology attachment packet interface (ATAPI), serial storage architecture (SSA), integrated drive electronics (IDE), and/or any combination thereof. The network coupled to network interface 160 and/or various components associated therewith may be implemented using hardware, software, or any combination thereof.

As depicted in FIG. 1, processor subsystem 120 may comprise a system, device, or apparatus operable to interpret and/or execute program instructions and/or process data, and may include a microprocessor, microcontroller, digital signal processor (DSP), application specific integrated circuit (ASIC), or another digital or analog circuitry configured to interpret and/or execute program instructions and/or process data. In some embodiments, processor subsystem 120 may interpret and/or execute program instructions and/or process data stored locally (e.g., in memory subsystem 130). In the same or alternative embodiments, processor subsystem 120 may interpret and/or execute program instructions and/or process data stored remotely (e.g., in a network storage resource, not shown).

Also in FIG. 1, memory subsystem 130 may comprise a system, device, or apparatus operable to retain and/or retrieve program instructions and/or data for a period of time (e.g., computer-readable media). Memory subsystem 130 may comprise random access memory (RAM), electrically erasable programmable read-only memory (EEPROM), a PCMCIA card, flash memory, magnetic storage, opto-magnetic storage, and/or a suitable selection and/or array of volatile or non-volatile memory that retains data after power to its associated information handling system, such as system 100, is powered down. Local storage resource 150 may comprise computer-readable media (e.g., hard disk drive, floppy disk drive, CD-ROM, and/or other type of rotating storage media, flash memory, EEPROM, and/or another type of solid state storage media) and may be generally operable to store instructions and/or data. In system 100, I/O subsystem 140 may comprise a system, device, or apparatus generally operable to receive and/or transmit data to/from/within information handling system 100. I/O subsystem 140 may represent, for example, a variety of communication interfaces, graphics interfaces, video interfaces, user input interfaces, and/or peripheral interfaces. As shown, I/O subsystem 140 may comprise touch panel 142 and display adapter 144. Touch panel 142 may include circuitry for enabling touch functionality in conjunction with a display device that is driven by display adapter 144. It is noted that when information handling system 100 is a laptop computer with an integrated display device, display adapter 144 may provide connectivity for an external display.

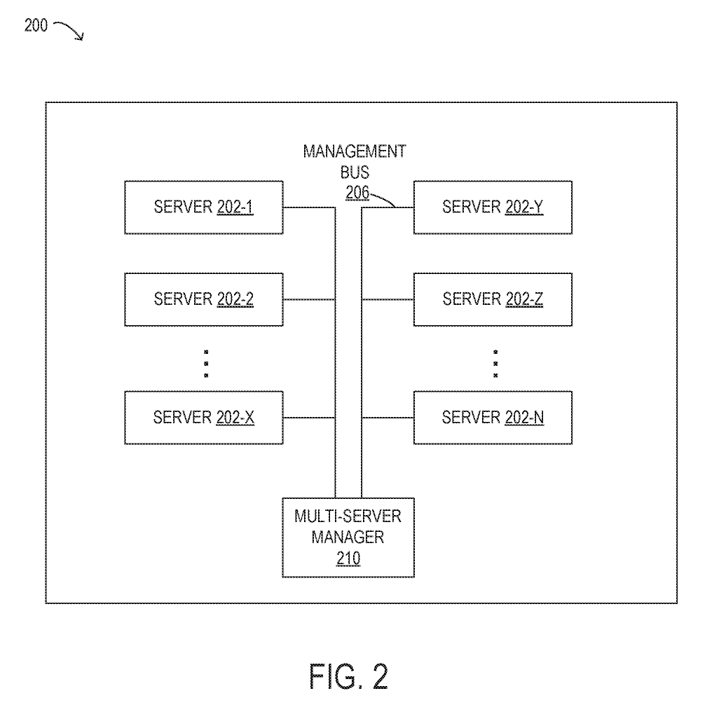

FIG. 2 is a block diagram of selected elements of an embodiment of an information handling system 200 that includes multiple servers 202 and a multi-server manager (MSM) 210. In some embodiments, MSM 210 or any of the servers 202 may include elements similar to those of information handling system 100 illustrated FIG. 1. In this example, system 200 includes n servers 202. In some embodiments, servers 202 may be rack-mounted servers. In other embodiments, servers 202 may be blade servers. In some embodiments, MSM 210 may be a “chassis management controller” that performs management functions on behalf of all of the servers 202 of information handling system 200. In other embodiments, MSM 210 may be implemented as (or within) a “remote access controller” that performs management functions on behalf of (and between) various rack servers. In this example embodiment, system 200 includes a management bus 206 over which commands and/or data may be communicated from MSM 210 to various ones of the servers 202, and over which notifications and/or data may be communicated from various ones of the servers 202 to MSM 210.

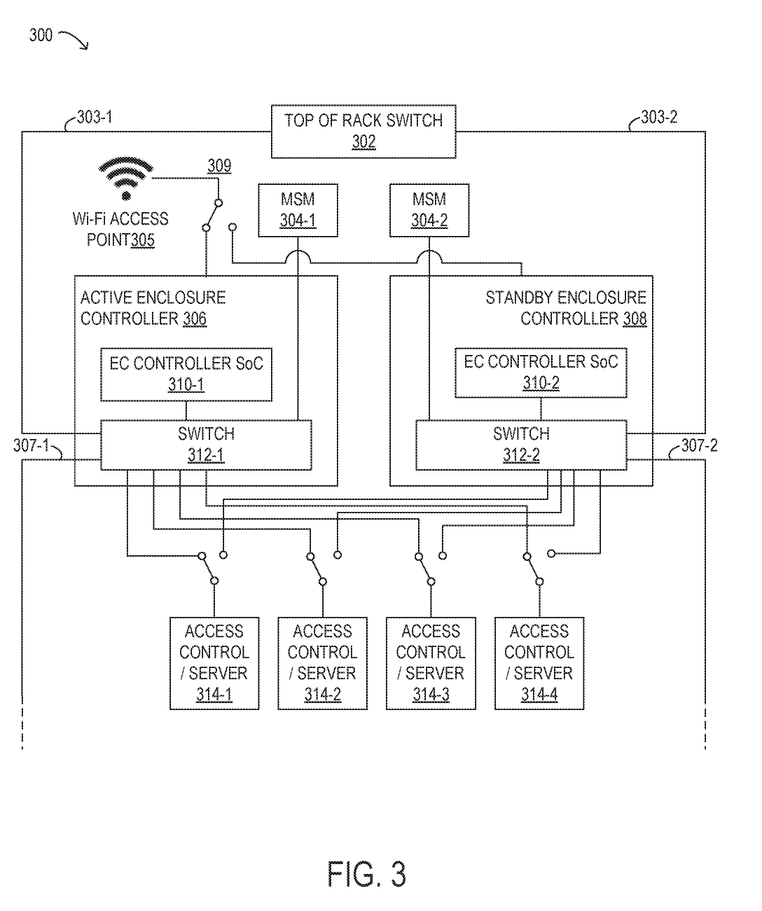

In some embodiments, an information handling system may include multiple rack servers, one of which may include an “at-the-box” Wi-Fi network that is configured automatically near field communication (NFC). In other embodiments, such a rack server may include an “at-the-box” Wi-Fi network that is configured automatically using Bluetooth Low Energy (BLE). In some systems there may be one Wi-Fi Access Point (AP) per rack server. In other systems, such as system 300 illustrated in FIG. 3 and described below, a single “at-the-box” Wi-Fi AP may be connected to an active Enclosure Controller (EC) and shared for all access controllers/servers, multi-server managers, and input/output modules.

FIG. 3 is a block diagram of selected elements of an information handling system 300 in a modular server architecture, according to some embodiments. In some embodiments of a modular server architecture, storage and other resources, including networking or management resources, may reside outside of the server modules and may be made available to multiple servers inside a single chassis on an as needed basis. As illustrated in FIG. 3, system 300 may include an active Enclosure Controller (EC) 306 and a standby Enclosure Controller (EC) 308. Each EC may include a respective EC controller 310, which may include a system-on-a-chip (SoC), and a respective switch 312. As illustrated in FIG. 3, system 300 may also include a top-of-rack switch 302 that is coupled to the switches 312-1 and 312-2 by uplinks 303-1 and 303-2, respectively. In some embodiments, switches 312-1 and 312-2 may be coupled to similar switches within a respective pair of active and standby Enclosure Controllers (ECs) by links 307-1 and 307-2, respectively.

As illustrated in FIG. 3, switches 312-1 and 312-2 may be controlled, at least in part, by EC Controller SoCs 310-1 and 310-2, respectively. For example, in FIG. 3, EC Controller SoC 310-1 may control the operation of switch 312-1, causing it to connect four other resources (shown as access control/server elements 314-1, 314-2, 314-3, and 314-4) to active EC 306. Similarly, EC Controller SoC 310-2 may control the operation of switch 312-2, causing it to refrain from connecting any of the four resources (shown as access control/server elements 314-1, 314-2, 314-3, and 314-4) to standby EC 308. In the example illustrated in FIG. 3, switch element 309 is configured to connect active EC 306, rather than standby EC 308, to Wi-Fi access point 305.

In some embodiments of the present disclosure, an unused VLAN may be allocated for use as a customized, secure Wi-Fi network on behalf of a client or multiple clients of a given tenant. In some embodiment, the VLAN may be allocated for a predetermined fixed timeout period, after which it may be dismantled and its resources returned to a pool for subsequent reallocation. In other embodiment, the VLAN may be allocated to a client or tenant through a lease mechanism, and the lease may be renewable.

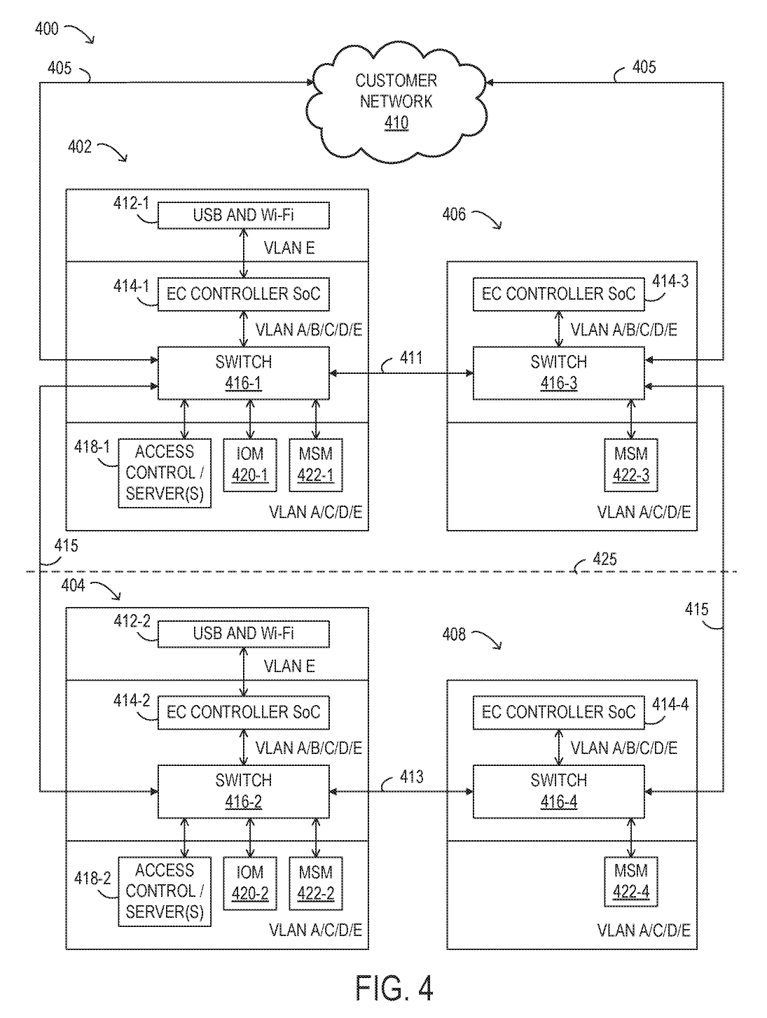

FIG. 4 is a block diagram of selected elements of an information handling system 400 in a stacked chassis architecture, according to some embodiments. As illustrated in FIG. 4, system 400 may include four chassis, shown as chassis 402, chassis 404, chassis 406, and chassis 408. These chassis are stacked in pairs on either side of stacked chassis division shown as 425. In this example, chassis 402 is an active chassis and is associated, for purposes of redundancy, with standby chassis 406. Similarly, chassis 404 is an active chassis and is associated, for purposes of redundancy, with standby chassis 408. Each chassis includes a respective EC controller SoC 414, a respective switch 416, and a respective multi-server manager (MSM) 422. In addition, each active chassis includes a respective USB and Wi-Fi element 412, multiple access control/server elements 418 (e.g., 8 or 16 access control/server elements 418), and a respective input/output module (IOM) 420. In various embodiments, an IOM 420 may represent an actual switch that can be plugged into the back of a chassis for the use of customer traffic, or may be a pass-through device. In various embodiments, each of the IOMs 420 may be an I/O switch that the access control/server elements 418 connect to, such as an Ethernet switch, a switch that conforms to the InfiniBand™ communications standard, a switch that conforms to the Fibre Channel protocol, a switch that conforms to the PCI™ or PCI Express® specification, a switch in accordance with the Omni-Path Architecture developed by Intel Corporation, or another type of switch. In at least some embodiments, these switches may be configured to pass user traffic, but not management traffic.

In system 400, links 405 connect active chassis 402 and standby chassis 406 to customer network 410 through their respective switches 416. A customer may have access to EC controller SoCs 414-1 and 414-2, and any of the resources 418-1, 420-1, 422-1, and 422-2 over links 405. In system 400, there is one VLAN B on link 411 between switch 416-1 on active chassis 402 and switch 416-3 on standby chassis 406, and a separate VLAN B on link 413 between switch 416-2 on active chassis 404 and 416-4 on standby chassis 408. In system 400, VLAN C provides internal chassis links, such as between the EC controller SoCs 414 and various resources in an active/standby chassis pair. In system 400, VLAN D provides a chassis-to-chassis private link between stacked chassis (shown as link 415). In system 400, LAN A is on links 405, 411, 413 and 415.

In at least some embodiments of the present disclosure, the only link that the customer traffic does not flow on is the link to the “at-the-box” network. In such embodiments, for security reasons, the “at-the-box” network may not be bridged with the normal customer management network. In system 400, VLAN E provides an “at-the-box” network connecting a mobile client to the respective EC controller SoCs 414 and various resources in an active/standby chassis pair through the respective USB and Wi-Fi element 412 in the chassis pair. In some embodiments, VLAN E may go to all ports that also go to other switches. In a given chassis, the MSM 422 may talk to the EC controller SoC 414 to control which VLANs are allowed on the switch ports, including the ports that connect to the access control/servers 418. While FIG. 4 illustrates a system that includes redundancy and stacked chassis, in other embodiments of the present disclosure, the techniques described herein for automatically provisioning multi-tenant wireless local area networks may be applied in a single-chassis system that includes a single MSM 422 and a single EC controller SoC 414. Logically, the redundancy and the stacking of the chassis illustrated in FIG. 4 may make multiple EC controller SoCs and multiple chassis appear as one logical chassis with one MSM.

In some embodiments of the present disclosure, a computer network may be partitioned or subdivided into multiple virtual LANs (VLANs), and the VLANs may be isolated from each other in the computer network. In some embodiments, multiple such VLANs may be reserved for specific purposes, while other VLANs may be reserved but unused. For example, a VLAN may be reserved for a customer network, for communication between an active EC and a corresponding standby EC, for an internal chassis VLAN, for a stacked chassis VLAN, for MSM-to-MSM communication, and/or for “at-the-box” Wi-Fi. In some systems, there may be as many as 15 unused reserved VLANs that could be used to create multiple “at the box” networks, as described herein. In some embodiments, e.g., in a stacked chassis situation, a master MSM may control all the other MSMs and therefore the entire stack. This master MSM may include circuitry or logic to determine which servers to connect to each of these additional VLANs. The master MSM may control which switch ports allow which VLANs. The master MSM may also manage the servers (e.g., through VLANs C and D) by communicating to the servers that they should connect to those VLANs and by automatically provisioning an IPv6 address on those VLANs. In some embodiments, if the switch port blocks the VLAN to a given server, or if a given server does not connect and acquire an IPv6 address on the VLAN, the “at-the-box” client may not be able to talk to that server.

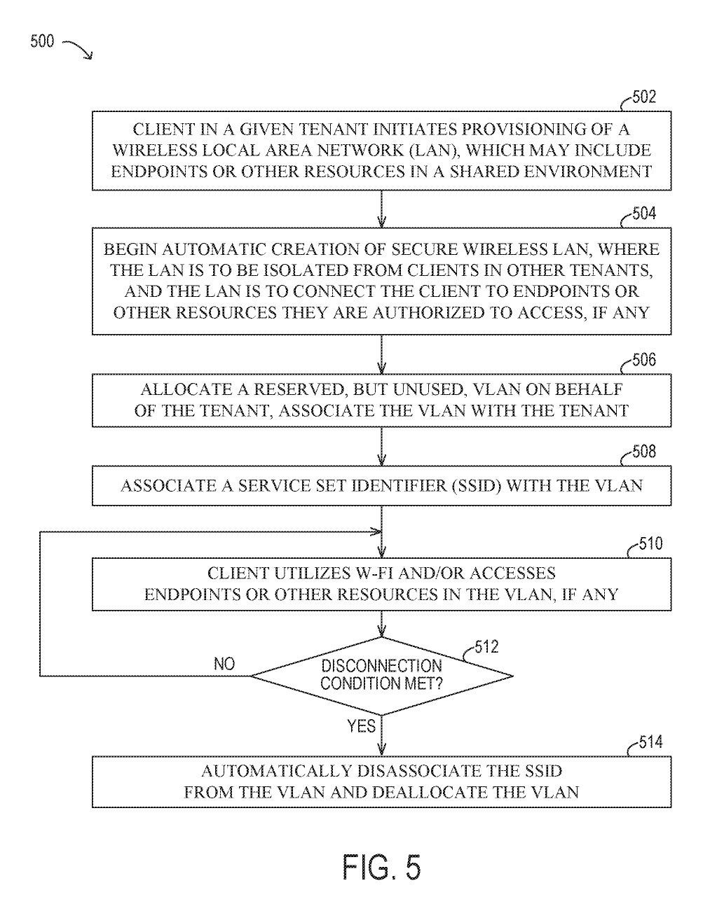

FIG. 5 is flowchart illustrating selected elements of a method 500 for automatically provisioning a multi-tenant wireless local area network, according to some embodiments. In various embodiments, method 500 may be performed by elements of an information handling system, such information handling system 100 illustrated in FIG. 1, information handling system 200 illustrated in FIG. 2, information handling system 300 illustrated in FIG. 3, or information handling system 400 illustrated in FIG. 4. In some embodiments, method 500 may be implemented by hardware circuitry, which may include any suitable combination of static (fixed-function), dynamic, and/or programmable logic devices. In other embodiments, one or more of the operations of method 500 may be performed or emulated by the execution of program instructions by a processor. Method 500 may include greater or fewer operations than those illustrated. Moreover, method 500 may execute its operations in an order different than those illustrated in FIG. 5. Method 500 may begin at any suitable operation and may terminate at any suitable operation. In some embodiments, method 500 may repeat operation at any suitable operation. Furthermore, method 500 may be executed multiple times to automatically provision two or more multi-tenant wireless local area networks. During the execution of method 500, other methods may be invoked to perform at least some of the operations of method 500.

As depicted in FIG. 5, method 500 may begin (at 502) with a client in a given tenant initiating the provisioning of a wireless local area network (LAN) in a shared computing environment. In some embodiments, the network may include one or more endpoints or other resources (such as switches or servers) in the shared computing environment. In different embodiments, some of which are described below, the client may initiate the provisioning of the LAN in different ways. For example, in one embodiment, initiating the provisioning of a wireless LAN may include the client providing a provisioning packet to a server in the shared computing environment. In another embodiment, the client may initiate the provisioning of a wireless LAB by requesting the creation of an SSID. In yet another embodiment, the client may initiate the provisioning of a wireless LAN by connecting a mobile device to a server using a near field communication mechanism, and sending a request to initiate the provisioning of a wireless LAB from an application executing on the mobile device In response to the client initiating the provisioning of the LAN, and regardless of the method by which the client initiates the provisioning of the LAN, method 500 may include (at 504) beginning the automatic creation of a secure wireless LAN, where the LAN is to be isolated from clients in other tenants in the shared computing environment, and the LAN is to connect the client only to the endpoints or other resources in the shared computing environment that they are authorized to access, if there are any.

Method 500 may include (at 506) allocating a reserved, but currently unused, VLAN on behalf of the tenant, and associating the VLAN with the tenant. Method 500 may also include associating a service set identifier (SSID) with the VLAN (as in 508). In some embodiments, the VLAN may be associated with another type of a locally unique identifier. In at least some embodiments, the SSID or other locally unique identifier may be automatically generated. For example, it may be automatically generated in response to a request to initiate the provisioning of a wireless LAN. Once the VLAN has been created, method 500 may include (at 510) the client utilizing the Wi-Fi network and/or accessing one or more endpoints or other resources in the VLAN, if there are any.

If (at 512) a disconnection condition is met for the VLAN subsequent to its creation, method 500 may proceed to 514, where the SSID may be automatically disassociated from the VLAN and the VLAN may be automatically deallocated. Otherwise, method 500 may return to 512 and the client may continue to access one or more endpoints or other resources in the VLAN until or unless a disconnection condition is met for the VLAN. In various embodiments, the disconnection conditions may include, but may not be limited to, a client (or all clients) disconnecting from the VLAN, a predetermined fixed timeout period expiring, or a lease expiring without being renewed. In some embodiments, once the VLAN is dismantled, its resources may be returned to a pool of such resources for subsequent reallocation. For example, the VLAN may subsequently be allocated on behalf of another client or tenant and may be associated with a different SSID and Wi-Fi password.

In various embodiments, the variable SSID approach described herein may be employed to automatically create a customized, secure Wi-Fi network and backend routing based on provisioning information provided by the client. This customized network may provide isolation from other clients and may provide end-to-end security.

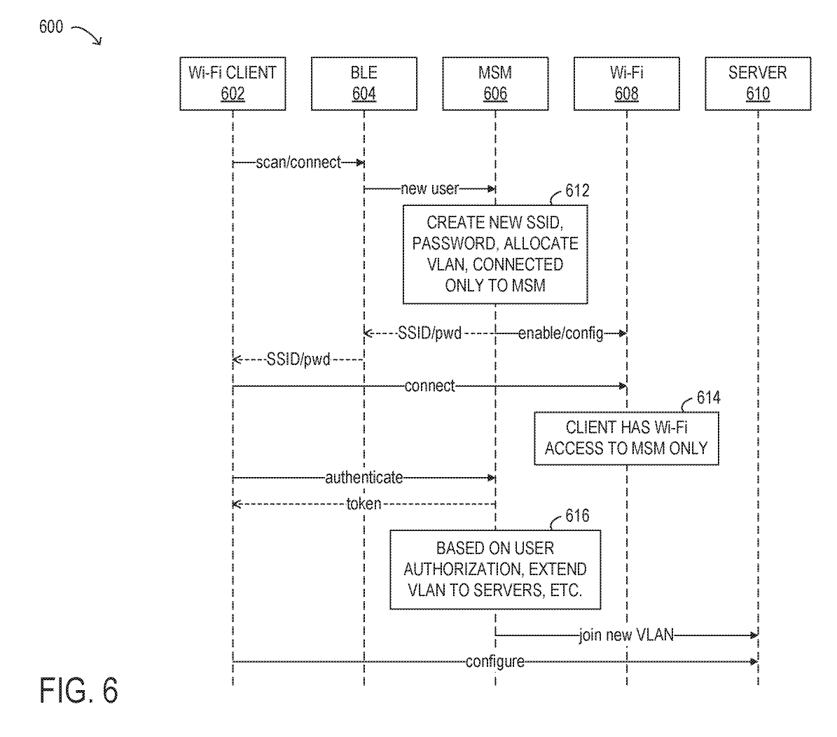

FIG. 6 is a sequence diagram 600 illustrating operations for automatically creating a secure Wi-Fi network based on provisioning information from a client, according to at least one embodiment. This sequence of operations can, in different embodiments, be implemented in an information handling system having any of a variety of architectures including, but not limited to, those illustrated in FIG. 1, FIG. 2, FIG. 3, and FIG. 4. In some embodiments, a sequence of operations for automatically creating a secure Wi-Fi network based on provisioning information from a client may include more, fewer, or different operations than those illustrated in FIG. 6, and those operations may be performed in an order different than that illustrated in FIG. 6.

In the illustrated embodiment, it may be assumed that the user has installed an application on a mobile device that uses near field communication technology to allow the user to establish two-way communication with a server's remote access controller when in close proximity to the server. In the illustrated embodiment, the user may press a button on the front of the chassis to enable Bluetooth Low Energy (BLE) and user scans for the chassis using the mobile application. This is illustrated in FIG. 6 as the “scan/connect” operation between Wi-Fi client 602 and BLE 604. In response to the scan/connect operation initiated by Wi-Fi client 602, a message may be sent to MSM 606 to obtain the authorization of the person who is trying to connect. If it is determined that the person is allowed to connect, they will be added to one of the unused VLANs.

For example, in the illustrated embodiment, the Enclosure Controller (EC) Bluetooth daemon informs the Modular Systems Management (MSM) that there is a new client that want to connect. This is illustrated as the “new user” communication between BLE 604 and MSM 606. As shown as 612, MSM 606 may create a new, random SSID and Wi-Fi password. MSM 606 may then allocate one of the available VLANs (which is connected only to MSM 606) and associate it with the SSID. The Wi-Fi SSID and password may then be returned to the client over Bluetooth. This is illustrated in FIG. 6 by the “SSID/pwd” communications from MSM 606 to BLE 604 and from BLE 604 to Wi-Fi client 602.

Once Wi-Fi client 602 receives the Wi-Fi SSID and password, the client may connect to the provided Wi-Fi (shown as the “connect” operation between Wi-Fi client 602 and Wi-Fi 608) and (at 614) discover the MSM (using e.g., multicast DNS or an MSM IPv6 address that is provided in the Bluetooth response). At this point, the client may authenticate with MSM 606. This is illustrated in FIG. 6 by the “authenticate” operation between Wi-Fi client 602 and MSM 606, and the return of a “token” from MSM 606 to Wi-Fi client 602. Based on the client's authorization, MSM 606 may instruct one or more access controllers/servers and/or IOMs that they have privileges to join the VLAN associated with this client. For example, in some embodiments, the MSM may send a message to all of the servers and/or other devices that it wants to add to the VLAN for this client. In response, they will enable that VLAN, after which they, and only they, will appear inside that network. In some embodiments, there may be a default set of permissions indicating servers and/or other devices to which the user has access. In some embodiments, after initially configuring access permissions to the default devices, the user may create additional users and may restrict their access to particular ones of the devices. In other embodiments, the initial user may give one or more of the additional users the same access rights that the initial user has.

Following authentication, the client may use the token it received from MSM 606 to configure, monitor, and/or remote desktop into the servers and IOMs that are on the VLAN associated with the client. This is illustrated in FIG. 6 at 616, by the “join new VLAN” operation between MSM 606 and server 610, and by the “configure” operation between Wi-Fi client 602 and server 610. In at least some embodiments, if the Wi-Fi client disconnects from the VLAN or if the client's connection times out, MSM 606 may automatically tear down the VLAN connections for this client so that the VLAN and Wi-Fi resources are made available for another tenant under a new SSID and password created for that tenant (not shown).

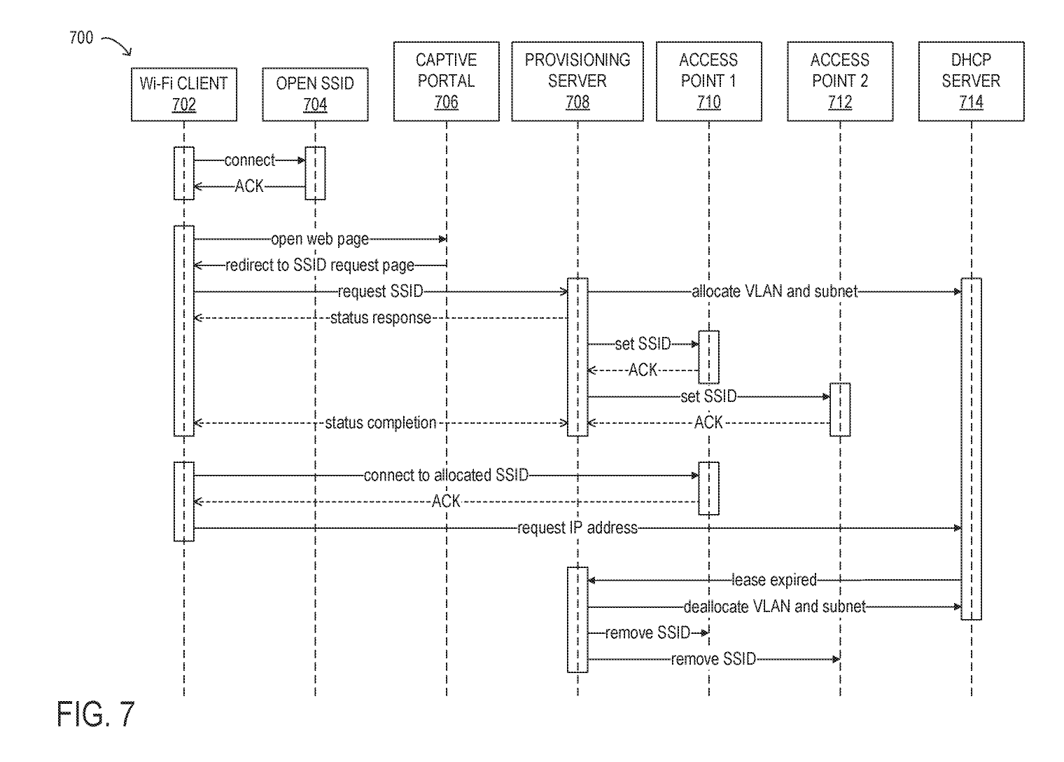

In some embodiments, the techniques described herein for automatically provisioning multi-tenant wireless local area networks may be employed in a multi-tenant environment, such as in a shared work space. For example, employees of the same tenant may want access to each other and to the Internet, but they may need to be separated from each other. While it may be possible to create a static SSID allocation for each tenant, that may involve too much overhead for tenants that turn over frequently. FIG. 7, which is described below, illustrates an example embodiment in which SSIDs can be dynamically allocated in a shared multi-tenant environment, according to some embodiments.

FIG. 7 is a sequence diagram 700 illustrating operations for automatically allocating a service set identifier (SSID) for a client in a multi-tenant environment, according to at least one embodiment. This sequence of operations can, in different embodiments, be implemented in an information handling system having any of a variety of architectures including, but not limited to, those illustrated in FIG. 1, FIG. 2, FIG. 3, and FIG. 4. In some embodiments, a sequence of operations for automatically allocating a service set identifier (SSID) for a client in a multi-tenant environment may include more, fewer, or different operations than those illustrated in FIG. 7, and those operations may be performed in an order different than that illustrated in FIG. 7.

In the illustrated embodiment, a Wi-Fi client 702 may connect to a guest network (shown as open SSID 704). This is illustrated in FIG. by the “connect” and corresponding acknowledge (“ACK”) operations between Wi-Fi client 702 and open SSID 704. Wi-Fi client 702 may also connect to a captive portal 706 that has access to a provisioning server 708. In some embodiments, when the client connects to a captive portal and ties to access any website, it may be redirected to its internal implementation of that web page to verify the user's identity or to perform some other level of authentication. This is illustrated in FIG. 7 by the “open web page” and “redirect to SSID request page” operations between Wi-Fi client 702 and captive portal 706. Note that a captive portal may not, itself, provide any method to create tenant boundaries. Instead, a captive portal generally provides any authorized client access to the same thing, i.e., the Internet.

In the embodiment illustrated in FIG. 7, Wi-Fi client 702 may request that an SSID be created. This is illustrated as the “request SSID” operation between Wi-Fi client 702 and provisioning server 708. In some embodiments, depending on any applicable policies, the client may be able to request a specific SSID name and password. In other embodiments, the provisioning server 708 may generate and return them to the client, as shown by the “status response” between provisioning server 708 and Wi-Fi client 702. The provisioning server 708 may then allocate a VLAN and IP address range (or IPv6 prefix) on a Dynamic Host Configuration Protocol (DHCP) server for the client. This is illustrated in FIG. 7 as the “allocate VLAN and subnet” operation between provisioning server 708 and DHCP server 714.

The provisioning server 708 may configure the new SSID on all Wi-Fi Access Points (APs) and bridges and may add the SSID to the allocated VLAN. This is illustrated in FIG. 7 by the “set SSID” and corresponding acknowledge (“ACK”) operation pairs between provisioning server 708 and access point 1 (710), and between provisioning server 708 and access point 2 (712). The client 702 may use the new SSID and password to connect to one or more of these access points. This is illustrated in FIG. 7 by the “connect to allocated SSID” and corresponding acknowledge (“ACK”) operations between Wi-Fi client 702 and access point 1 (710).

The client 702 may also use the new SSID and password to connect to and gain a lease from the DHCP server 714. This is illustrated by the “request IP address” operation between Wi-Fi client 702 and DHCP server 714. In at least some embodiments, Wi-Fi client 702 can give this username and password to other co-workers of the same tenant. In other words, each tenant may be multiple individuals, and those individuals may share an SSID and password to the network in order to share content with each other, while remaining isolated from individuals in other tenants.

In the illustrated embodiment, as clients disconnect from the network (or after some pre-determined amount of time passed) their leases with the DHCP server will expire. For example, in at least some embodiments, these leases may be for a very short period of time, such as for 30 minutes or an hour, and they may be renewable. When a lease expires without being renewed, the DHCP server 714 may notify the provisioning server 708 of the expiration of the DHCP lease. This is illustrated in FIG. 7 by the “lease expired” operation between DHCP server 714 and provisioning server 708. Once there are no more clients on the allocated SSID, the provisioning server 708 may automatically remove the SSID from all APs and deallocate the VLAN and subnet. This is illustrated in FIG. 7 by the “deallocate VLAN and subnet” operation between provisioning server 708 and DHCP server 714, and the “remove SSID” operations between provisioning server 708 and Wi-Fi access points 1 and 2 (shown as 710 and 712, respectively).

In at least some embodiments, the variable SSID approach described herein includes the automatic creation of VLANs to isolate tenants on both the wireless segment and on the wired side. In some embodiments, the variable SSID approach described herein allows multiple clients from the same tenant to communicate with each other. As described herein, the variable SSID approach includes automatically creating a virtual wireless network, associating it with a tenant and, potentially, removing the association so that the resources can be used by another tenant. While several specific embodiments of the variable SSID approach are described herein, these are only examples and are not intended to be limiting.

The above disclosed subject matter is to be considered illustrative, and not restrictive, and the appended claims are intended to cover all such modifications, enhancements, and other embodiments which fall within the true spirit and scope of the present disclosure. Thus, to the maximum extent allowed by law, the scope of the present disclosure is to be determined by the broadest permissible interpretation of the following claims and their equivalents, and shall not be restricted or limited by the foregoing detailed description.

What is claimed is:

1. A method, comprising, in an information handling system:
detecting initiation, by a client in a given tenant, of a provisioning of a wireless local area network (LAN);
creating, automatically and in response to the detecting, a secure wireless LAN, wherein the LAN is to be isolated from clients in tenants other than the given tenant, and wherein creating the secure wireless LAN comprises:
allocating a virtual local area network (VLAN) on behalf of the tenant;
associating the VLAN with the tenant; and
associating a locally unique identifier with the VLAN;
determining, subsequent to the creating, that a disconnection condition for the VLAN has been met; and
dismantling, automatically and in response to the determination, the VLAN, wherein dismantling the VLAN comprises:
disassociating the locally unique identifier from the VLAN; and
deallocating the VLAN.

2. The method of claim 1, wherein detecting initiation, by a client in a given tenant, of a provisioning of a wireless LAN comprises:
receiving from the client, a provisioning packet.

3. The method of claim 1, wherein creating the secure wireless LAN further comprises allocating an IP address range for the tenant.

4. The method of claim 1, further comprising:
communicating the locally unique identifier to one or more wireless access points.

5. The method of claim 1, wherein detecting initiation, by a client in a given tenant, of a provisioning of a wireless LAN comprises:
receiving a request from the client for creation of a locally unique identifier for a VLAN.

6. The method of claim 1, further comprising:
adding, to the VLAN, one or more endpoint devices or shared resources in the information handling system that the client is authorized to access.

7. The method of claim 1, wherein determining that a disconnection condition for the VLAN has been met comprises:
detecting that the client has disconnected from the VLAN.

8. The method of claim 1, wherein determining that a disconnection condition for the VLAN has been met comprises:
determining that a predetermined timeout period or lease period for the VLAN has expired.

9. The method of claim 1, wherein detecting initiation, by a client in a given tenant, of a provisioning of a wireless LAN comprises:
determining, using a near field communication mechanism, that a mobile device of the client is in close proximity to a server in the information handling system; and
receiving, from the mobile device, a request to initiate provisioning of a wireless LAN.

10. The method of claim 1, further comprising:
adding one or more other clients in the given tenant to the VLAN.

11. An information handling system, comprising:
at least one wireless access point;
a network subdivided into a plurality of virtual local area networks (VLANs);
circuitry to:
detect initiation, by a client in a given tenant, of a provisioning of a wireless local area network (LAN);
create, automatically and in response to the detection, a secure wireless LAN, wherein the LAN is to be isolated from clients in tenants other than the given tenant, and wherein to create the secure wireless LAN, the information handling system comprises circuitry to:
allocate a VLAN on behalf of the tenant;
associate the VLAN with the tenant; and
associate a locally unique identifier with the VLAN;
determine, subsequent to the creation, that a disconnection condition for the VLAN has been met; and
dismantle, automatically and in response to the determination, the VLAN, wherein to dismantle the VLAN, the information handling system comprises circuitry to:
disassociate the locally unique identifier from the VLAN; and
deallocate the VLAN.

12. The information handling system of claim 11, wherein to detect initiation, by a client in a given tenant, of a provisioning of a wireless LAN, the information handling system comprises circuitry to:
receive from the client, a provisioning packet.

13. The information handling system of claim 11, wherein to create the secure wireless LAN, the information handling system comprises circuitry to:
allocate an IP address range for the tenant.

14. The information handling system of claim 11, further comprising circuitry to:
communicate the locally unique identifier to one or more wireless access points.

15. The information handling system of claim 11, wherein to detect initiation, by a client in a given tenant, of a provisioning of a wireless LAN, the information handling system comprises circuitry to:
receive a request from the client for creation of a locally unique identifier for a VLAN.

16. The information handling system of claim 11, further comprising circuitry to:
add, to the VLAN, one or more endpoint devices or shared resources that the client is authorized to access.

17. The information handling system of claim 11, wherein to determine that a disconnection condition for the VLAN has been met, the information handling system comprises circuitry to:
detect that the client has disconnected from the VLAN.

18. The information handling system of claim 11, wherein to determine that a disconnection condition for the VLAN has been met, the information handling system comprises circuitry to:
determine that a predetermined timeout period or lease period for the VLAN has expired.

19. The information handling system of claim 11, wherein to detect initiation, by a client in a given tenant, of a provisioning of a wireless LAN, the information handling system comprises circuitry to:
determine, using a near field communication mechanism, that a mobile device of the client is in close proximity to a server in the information handling system; and
receive, from the mobile device, a request to initiate provisioning of a wireless LAN.

20. The information handling system of claim 11, further comprising circuitry to:
add one or more other clients in the given tenant to the VLAN.
